(19) United States
(12) Patent Application Publication
(10) Pub. No.: US 2026/0229139 A1
(43) Pub. Date: Aug. 6, 2026

(54) OPERATING METHOD FOR CONFIGURING MODEL PERFORMING REINFORCEMENT LEARNING RELATED TO TASK PLANNING AND ELECTRONIC APPARATUS SUPPORTING THEREOF

(71) Applicant: AGENCY FOR DEFENSE DEVELOPMENT, Daejeon (KR)

(72) Inventors: Sun Ju LEE, Daejeon (KR); Do Hyung KIM, Daejeon (KR); Beom Ki KIM, Seoul (KR)

(21) Appl. No.: 19/233,189

(22) Filed: Jun. 10, 2025

(30) Foreign Application Priority Data
Feb. 6, 2025 (KR) 10-2025-0015374

(51) Int. Cl. G09B 9/00; G06N 20/00

(52) U.S. Cl. CPC G09B 9/003; G06N 20/00

(57) ABSTRACT

Provided is a method of configuring a model by an electronic apparatus, the method including designing a multi-agent reinforcement learning structure to perform reinforcement learning based on each agent configured to correspond to each military unit identified as a target of task planning in a virtual battlespace simulation, and configuring a model performing reinforcement learning related to task planning for each military unit based on the multi-agent reinforcement learning structure.

### PRIORITY INFORMATION

This application claims the benefit of Korean Patent Application No. 10-2025-0015374, filed on Feb. 6, 2025, in the Korean Intellectual Property Office, the disclosure of which is incorporated herein by reference.

### FIELD OF THE INVENTION

Example embodiments relate to a method of configuring a model performing reinforcement learning related to task planning and an electronic apparatus supporting thereof, and more particularly, to a method of configuring a model performing reinforcement learning related to task planning for a military unit based on a multi-agent reinforcement learning structure and an electronic apparatus supporting thereof.

### DISCUSSION OF THE RELATED ART

In a battlespace situation, a military commander and a staff officer plan a task to assign a subordinate unit to achieve an assigned mission. According to an existing manner, a task to be assigned to a subordinate unit is planned based on an analysis and a determination of a commander and a staff officer, which is a manner of depending on an experience of a decision maker and may enable an analysis and a determination from various perspectives with reflection of individual capability. However, the quality of the result of decision-making may vary depending on individual capability, and when quick decision-making is required in a real battlespace situation, a thorough review of a variety of information and situations may be difficult to conduct. Accordingly, when planning a task for a subordinate unit, a scientific approach to support decision-making of commanders and staff officers may be required.

In many cases of decision-making by a commander and a staff officer, since an obvious answer is not present, research on task planning continues, focusing on the latest artificial intelligence (AI) technology using reinforcement learning. As an example of related art documents, research on recommending a policy in a battlespace situation using reinforcement learning has been conducted, and the related art document suggests a reinforcement learning model structure in a general form that interacts with a battlespace situation simulator. The related art document suggests a method of an agent exploring an optimal action through reinforcement learning, but fails to consider tasks of various forms such as tactical maneuver, detour, seizure, and/or occupation assigned to a subordinate unit by a commander of a higher-level military unit.

As another example of related art documents, research on deriving an expected policy of an enemy and a mission of a friendly force by analyzing a mission through a knowledge base based on natural language processing and a knowledge graph and establishing a policy for the friendly force through reinforcement learning, has been conducted. However, in the case of a hierarchical reinforcement learning model that is suggested in the related art document, it is difficult to specifically identify the exact configuration, and in addition, research on recommending an appropriate policy in a battlespace situation by utilizing a supervised learning technique, to which a regression model based on deep learning is applied, may be identified, but there is a practical limitation in obtaining a wealth of battlespace situation information for learning.

With regard thereto, related art documents such as KR10-2362749B1, KR10-2567928B1, and KR10-2024-0157520A may be referenced.

### SUMMARY OF THE INVENTION

Accordingly, the present invention is directed to an operating method for configuring model performing reinforcement learning related to task planning and an electronic apparatus supporting thereof that substantially obviates one or more problems due to limitations and disadvantages of the related art.

An aspect provides a method of configuring a model performing reinforcement learning related to task planning for a military unit based on a multi-agent reinforcement learning structure by an electronic apparatus.

Technical goals of the present disclosure are not limited to the aforementioned technical goals, and other unstated technical goals may be clearly understood by those skilled in the art from the following description.

According to various example embodiments, there is provided an operating method of configuring a model performing reinforcement learning related to task planning for a military unit by an electronic apparatus and an electronic apparatus supporting thereof.

According to an aspect, there is provided a method of configuring a model by an electronic apparatus, the method including designing a multi-agent reinforcement learning structure to perform reinforcement learning based on each agent configured to correspond to each military unit identified as a target of task planning in a virtual battlespace simulation and configuring a model performing reinforcement learning related to task planning for each military unit based on the multi-agent reinforcement learning structure. The multi-agent reinforcement learning structure is designed to include each agent reinforcement learning structure configured to correspond to each agent in order that each agent learns the task planning for each military unit. Each agent reinforcement learning structure may include an attention network structure generating battlespace information reflecting an importance of each military unit based on information about each military unit identified through the virtual battlespace simulation, and a task selection network structure determining and selecting a task to be performed by each military unit based on the battlespace information among one or more tasks performable by each military unit in the virtual battlespace simulation.

According to an example embodiment, an embedding vector including the information about each military unit may be input into the attention network structure. The embedding vector including the information about each military unit may be reconfigured to an embedding vector of each military unit and an embedding vector corresponding to a characteristic of each agent. Based on the embedding vector of each military unit and the embedding vector corresponding to the characteristic(s) of each agent, each unit battlespace information determined with regard to each military unit and each weight assigned to each military unit with respect to each agent in the virtual battlespace simulation are calculated. The battlespace information reflecting the information about each military unit may be generated based on an operation over each unit battlespace information and each weight.

According to an example embodiment, the task selection network structure may include a selection network selecting the task to be performed by each military unit among the one or more tasks, and each task network generating information about each task when each task included in the one or more tasks is selected by the selection network. The task selection network structure may output information about the task selected for each military unit to perform based on the selection network and each task network. The information about the task selected for each military unit to perform may include task instruction information for instructing the task selected for each military unit to perform among the one or more tasks and input value information for the task selected for each military unit to perform.

According to an example embodiment, each agent may be configured to learn the task planning for each military unit based on a single-agent reinforcement learning algorithm.

According to an example embodiment, a learning scenario for the virtual battlespace simulation may be configured to be automatically generated.

According to an example embodiment, the method of configuring the model may further include beginning the virtual battlespace simulation according to a learning scenario based on a battlespace environment simulator, in response to the beginning of the virtual battlespace simulation, obtaining each initial observation information identified with regard to each military unit from the battlespace environment simulator, and obtaining information, which is output by the model corresponding to each initial observation information, about the task to be performed by each military unit.

According to an example embodiment, the method of configuring the model may further include inputting the information about the task to be performed by each military unit into the battlespace environment simulator, in response to a result of conducting the virtual battlespace simulation on the battlespace environment simulator based on inputting the information about the task to be performed by each military unit, identifying each observation information identified with regard to each military unit and each reward information about each agent according to each observation information, and updating the model based on each observation information and each reward information.

According to an example embodiment, updating the model may be performed until an episode termination condition of the virtual battlespace simulation and a learning termination condition of the reinforcement learning for the task planning of each military unit are satisfied.

According to another aspect, there is provided a non-transitory computer-readable storage medium having a program for executing a method of configuring a model on a computer according to various example embodiments, the method including designing a multi-agent reinforcement learning structure to perform reinforcement learning based on each agent configured to correspond to each military unit identified as a target of task planning in a virtual battlespace simulation and configuring a model performing reinforcement learning related to task planning for each military unit based on the multi-agent reinforcement learning structure. The multi-agent reinforcement learning structure may be designed to include each agent reinforcement learning structure configured to correspond to each agent in order that each agent learns the task planning for each military unit. Each agent reinforcement learning structure may include an attention network structure generating battlespace information reflecting an importance of each military unit based on information about each military unit identified through the virtual battlespace simulation, and a task selection network structure determining and selecting a task to be performed by each military unit based on the battlespace information among one or more tasks performable by each military unit in the virtual battlespace simulation.

According to another aspect, there is provided an electronic apparatus configuring a model, the electronic apparatus including a processor and one or more memories configured to store one or more instructions. The one or more instructions, when executed, may control the processor to perform designing a multi-agent reinforcement learning structure to perform reinforcement learning based on each agent configured to correspond to each military unit identified as a target of task planning in a virtual battlespace simulation and configuring a model performing reinforcement learning related to task planning for each military unit based on the multi-agent reinforcement learning structure. The multi-agent reinforcement learning structure may be designed to include each agent reinforcement learning structure configured to correspond to each agent in order that each agent learns the task planning for each military unit. Each agent reinforcement learning structure may include an attention network structure generating battlespace information reflecting an importance of each military unit based on information about each military unit identified through the virtual battlespace simulation and a task selection network structure determining and selecting a task to be performed by each military unit based on the battlespace information among one or more tasks performable by each military unit in the virtual battlespace simulation.

Various example embodiments of the present disclosure described above represent merely some of the example embodiments of the present disclosure and example embodiments reflecting technical features of various example embodiments of the present disclosure may be derived and understood by those skilled in the art based on the detailed description below.

According to example embodiments, it is possible to provide a method of configuring a model performing reinforcement learning related to task planning for a military unit based on a multi-agent reinforcement learning structure by an electronic apparatus and effectively determine task planning for each military unit through the model in response to a continuously changing battlespace situation.

It is to be understood that both the foregoing general description and the following detailed description are examples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating a configuration of an electronic apparatus;

FIG. 2 is a diagram illustrating a flowchart of a method of configuring a model by an electronic apparatus;

FIG. 3 is a diagram illustrating an example of planning a task for a subordinate unit based on a model;

FIG. 4 is a diagram illustrating an example of a multi-agent reinforcement learning structure designed for a model;

FIG. 5 is a diagram illustrating an example of an operation of an attention network structure and a task selection network structure included in a multi-agent reinforcement learning structure;

FIG. 6 is a diagram illustrating an example of learning performed based on a model and a battlespace environment simulator; and

FIG. 7 is a diagram illustrating an entire flowchart in which learning for task planning for a unit is performed according to an example embodiment of the present disclosure.

### DETAILED DESCRIPTION OF THE EXAMPLE EMBODIMENTS

Hereinafter, various example embodiments of the present disclosure will be described in detail with reference to the accompanying drawings for those of ordinary skill in the art to which the present disclosure pertains to easily implement the example embodiments. The detailed description disclosed below is intended to describe exemplary embodiments of various example embodiments and is not limited to specific embodiments.

Terms used in example embodiments are selected, as much as possible, from general terms that are widely used at present while taking into consideration the functions of the present disclosure, but these terms may be replaced by other terms based on intentions of those skilled in the art, judicial precedent, the advent of new technologies, or the like. Also, in a particular case, terms are arbitrarily selected by the applicant of the present disclosure, and in this case, the meanings of these terms will be described in detail in the corresponding descriptions. Accordingly, the terms used herein should not be defined simply as the designations but based on the meanings thereof and the overall context of the present disclosure.

Example embodiments below are a combination of elements and features of various example embodiments in a predetermined form. Each element or feature may be considered as an option unless otherwise indicated. Each element or feature may be embodied in a form of not being combined with other elements and features. In addition, various example embodiments may be configured by some elements and features being combined together. A sequence of operations described in various example embodiments may change. Some elements or features of any example embodiment may be included in another example embodiment or replaced by a corresponding element or feature of another example embodiment.

In description about the drawings, a procedure or a step that may obscure the gist of various example embodiments is not described, and a procedure or a step at a level that those skilled in the art may understand is not described, either.

Throughout the specification, when an element is referred to as “comprising or including” another element, it should not be understood as excluding other elements, but as further including other elements unless otherwise particularly indicated. In this specification, a singular expression of a noun corresponding to an item may be used to include both a singular meaning and a plural meaning unless otherwise clearly indicated or contradicted in context. In this specification, each expression “A or B,” “at least one of A and B,” “at least one of A or B,” “A, B, or C,” “at least one of A, B, and C,” and “at least one of A, B, or C” may include any one of items enumerated together in a corresponding expression or every possible combination thereof. Terms such as “first” and “second” may be merely used to distinguish a corresponding element from another corresponding element and do not limit a corresponding element in another aspect (for example, importance or sequence).

Each of elements (for example, a module or a program) described in this specification may include a singular or plural entity. According to various example embodiments, one or more elements or operations among corresponding elements may be omitted or one or more other elements or operations may be added. Additionally, a plurality of elements (for example, a module or a program) may be integrated into one element. In this case, an integrated element may perform one or more functions of each of the plurality of elements identically or similarly to what a corresponding element among the plurality of elements performs before integrated. According to various example embodiments, operations performed by a module or a program or another element may be implemented sequentially, in parallel, or repeatedly, or one or more operations may be implemented in another sequence, or omitted, or one or more other operations may be added.

Terms used in this specification such as “module” and “ . . . portion” may refer to a unit handling at least one function or operation and may include a unit embodied by hardware, software, firmware, or a combination thereof.

Various example embodiments in this specification may be implemented by software (for example, a program or an application) including one or more instructions stored in a storage medium (for example, a memory) readable by a machine. For example, a processor of the machine may call and execute at least one instruction among one or more stored instructions from the storage medium. This enables the machine to be operated to perform at least one function by at least one called instruction. One or more instructions may include a code generated by a compiler or a code executable by an interpreter. The storage medium readable by the machine may be provided in a form of a non-transitory storage medium. Here, “non-transitory” merely indicates that a storage medium is a tangible apparatus and does not include a signal and do not distinguish the case where data is stored in a storage medium semi-permanently from the case where data is stored in a storage medium temporarily.

In addition, specific terms used in various example embodiments are provided for clearer understanding of various example embodiments, and using these specific terms may change into another form within the scope of a technical idea of various example embodiments.

A method of configuring a model and an electronic apparatus supporting thereof suggested in the present disclosure may correspond to a method of configuring a model and an apparatus for task planning for a subordinate unit based on reinforcement learning that may reflect various tasks of a military to configure a reinforcement learning model to plan a task for a subordinate unit in response to a given battlespace situation by interacting with a battlespace environment simulator simulating a learning scenario and to teach a reinforcement learning model and infer and perform the task planning for a subordinate unit under a given battlespace situation through the trained reinforcement learning model.

Particularly, the method of configuring the model according to the present disclosure may be effectively applied to the national defense field that requires capability to command a unit in response to a battlespace situation changing in real time. For example, a command system in the national defense field should appropriately deploy and employ a subordinate unit according to various battlespace situations, and to support this, an assisting method that effectively supports the capability of a commander to deploy and employ a subordinate unit should be prepared. In response to this characteristic of the national defense field, the method of configuring a model suggested below in the present disclosure may be understood as a technical idea easily applicable to the national defense field in that the method may help a decision-making in a command system by being provided with a model learning to plan an appropriate task for a subordinate unit in a battlespace situation through a learning scenario regarding various battlespace situations.

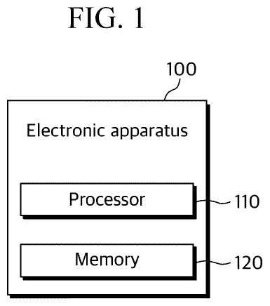

FIG. 1 is a diagram illustrating a configuration of an electronic apparatus.

Referring to FIG. 1, an electronic apparatus 100 may include, according to an example embodiment, a processor 110 and a memory 120. The electronic apparatus 100 illustrated in FIG. 1 shows elements only related to the present example embodiment, and it may be understood by those skilled in the art that other general-purpose elements in addition to elements illustrated in FIG. 1 may be further included.

For example, the electronic apparatus 100 may include a communication device including one or more transceivers, an input portion, and an output portion. The communication device is an apparatus for performing wire/wireless communication and may communicate with an external electronic apparatus. The external electronic apparatus may be a terminal or a server. In addition, communication technology used by the communication device may include global system for mobile communication (GSM), code division multi access (CDMA), long term evolution (LTE), 5G, wireless local area network (WLAN), wireless-fidelity (Wi-Fi), Bluetooth, radio frequency identification (RFID), infrared data association (IrDA), ZigBee, and near field communication (NFC). The input portion may be, for example, a keypad or a keyboard in a general form, a mouse, a microphone receiving a voice signal, a camera, or other various input devices detecting and receiving different forms of a user input. The output portion may be, for example, a display outputting a video, a speaker outputting sound, a haptic device generating vibration, or other different forms of output devices.

In addition, at least some elements within the electronic apparatus 100 may be integrated to be implemented, or implemented as a singular or plural entity. At least some elements within the electronic apparatus 100 may be connected to each other through a bus, general purpose input/output (GPIO), a serial peripheral interface (SPI), or a mobile industry processor interface (MIPI) and may exchange data and/or a signal.

The electronic apparatus 100 of FIG. 1 may configure a model. Specifically, the electronic apparatus 100 may design a multi-agent reinforcement learning structure for performing reinforcement learning based on each agent configured to correspond to each military unit identified as a target of task planning in a virtual battlespace simulation and may configure the model performing reinforcement learning related to the task planning for each military unit based on the multi-agent reinforcement learning structure. Here, the multi-agent reinforcement learning structure designed by the electronic apparatus 100 may include an each agent reinforcement learning structure configured to correspond to each agent in order that each agent learns the task planning for each military unit, and each agent reinforcement learning structure may include an attention network structure generating battlespace information reflecting an importance of each military unit based on information about each military unit identified through the virtual battlespace simulation and a task selection network structure determining and selecting a task to be performed by each military unit based on the battlespace information among one or more tasks performable by each military unit in the virtual battlespace simulation.

The processor 110 is an element that may perform an operation or data processing with regard to control and/or communication of each element of the electronic apparatus 100. For example, the processor 110 may overall control the electronic apparatus 100 by executing a program stored in the memory 120 within the electronic apparatus 100. The processor 110 may be embodied as a central processing unit (CPU), a graphics processing unit (GPU), or an application processor (AP) provided within the electronic apparatus 100, but is not limited thereto. Unless otherwise described, the processor 110 may refer to a set of one or more processors 110 in the present disclosure.

The processor 110 may be embodied as a computer or a similar device depending on hardware, software, or a combination thereof. Hardware-wise, the processor 110 may be embodied as a form of an electronic circuit performing a control function by processing an electric signal, and software-wise, embodied as a form of a program operating a hardware processor 110. Meanwhile, unless otherwise mentioned in the following description, it may be construed that an operation of the electronic apparatus 100 is performed by control of the processor 110. In other words, when modules embodied in the electronic apparatus 100 to configure the model are executed, it may be construed that the modules control the processor 110 to perform operations of the electronic apparatus 100 described below.

The memory 120 may be hardware storing various types of data processed within the electronic apparatus 100 and may temporarily or semi-permanently store data processed and to be processed in the electronic apparatus 100. For example, in the memory 120 of the electronic apparatus 100, data with regard to an operating system (OS) to operate the electronic apparatus 100 may be stored. The memory 120 may include random access memory (RAM) such as dynamic random access memory (DRAM) and static random access memory (SRAM), and read-only memory (ROM), electrically erasable programmable read-only memory (EEPROM), compact disc read-only memory (CD-ROM), a blue-ray or another optical disk storage, a hard disk drive (HDD), a solid state drive (SSD), or flash memory. The memory 120 may be provided as a built-in type or a removable type. In addition, the memory 120 may store instructions with regard to an operation of the processor 110. Unless otherwise described, the memory 120 may refer to a set of one or more memories 120 in the present disclosure.

The method of configuring the model of the present disclosure, performed by the electronic apparatus 100 of FIG. 1, may also be implemented by a non-transitory computer-readable storage medium (or a non-transitory recording medium) that a computer for the operation may read. The method of configuring the model may be implemented by a software module or an algorithm and stored in a computer-readable recording medium as computer-readable codes or program instructions executable in the processor 110. Here, the computer-readable recording medium may include a magnetic storage medium (for example, ROM, RAM, a floppy disk, or a hard disk) and an optical reading medium (for example, CD-ROM, or a digital versatile disc (DVD)). The computer-readable recording medium may be distributed to network-connected computer systems, so that the computer-readable code may be stored and executed in a distribution manner. The medium may be readable by a computer, stored in the memory 120, and executed in the processor 110.

The electronic apparatus 100 according to an example embodiment may further include a display (not illustrated). The display may visually provide a variety of information under control of the processor 110. The display may include a touch circuit configured to sense a touch of a user or a sensor circuit configured to measure the strength of power generated by a touch.

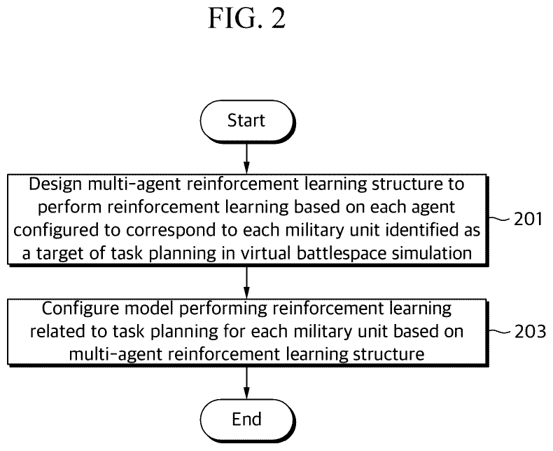

FIG. 2 is a diagram illustrating a flowchart of a method of configuring a model by an electronic apparatus.

The electronic apparatus 100 in FIG. 2 may design a multi-agent reinforcement learning structure to perform reinforcement learning based on each agent configured to correspond to each military unit identified as a target of task planning in a virtual battlespace simulation in operation 201 and configure a model performing reinforcement learning related to the task planning for each military unit based on the multi-agent reinforcement learning structure in operation 203.

In FIG. 2, the multi-agent reinforcement learning structure for the electronic apparatus 100 to configure the model may be designed to include each agent reinforcement learning structure configured to correspond to each agent in order that each agent learns the task planning for each unit. In addition, each agent reinforcement learning structure included in the multi-agent reinforcement learning structure may include an attention network structure generating battlespace information reflecting an importance of each unit based on information about each unit identified through the virtual battlespace simulation and a task selection network structure determining and selecting a task to be performed by each unit based on the battlespace information among one or more tasks performable by each unit in the virtual battlespace simulation.

Reinforcement learning may refer to a method of training an agent so that the agent makes a decision for a specific action corresponding to a specific state through interaction with a given environment in a specific environment to accomplish a goal, and an ultimate goal of the reinforcement learning may be understood as optimizing a policy determining an optimal action that may receive a maximum reward in a specific situation by the agent exploring various states. Through a manner of comparing an action determined corresponding to each state by an agent to an optimal action that is most suitable for each state to reward the agent when the action determined by the agent is identified as the optimal action, and on the contrary, to assign a penalty when the action determined by the agent is not identified as the optimal action, training may be conducted for an agent to determine an optimal action corresponding to each state to receive a maximum reward.

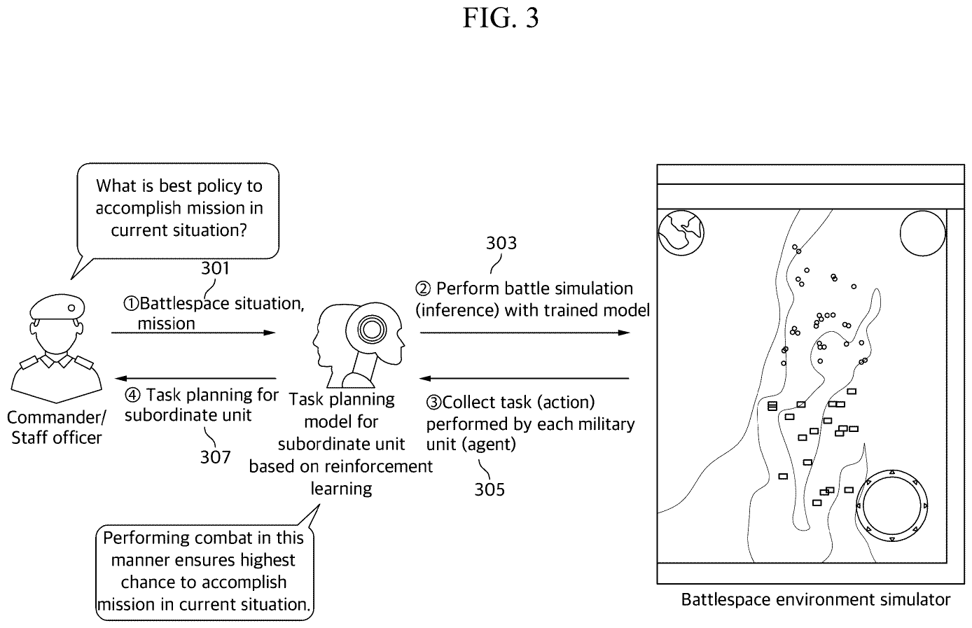

In the present disclosure, planning a task for a subordinate unit based on a reinforcement learning model configured by the electronic apparatus 100 may be as illustrated in FIG. 3. In the present disclosure hereinafter, the electronic apparatus 100, as an apparatus that performs an operation of configuring a model, may be understood as an apparatus performing various operations based on including the model or connecting to the model, and/or further including another composing portion or connecting to another composing portion.

FIG. 3 is a diagram illustrating an example of planning a task for a subordinate unit based on a model.

When a battlespace situation occurs and task planning for a subordinate unit is required, a commander or a staff officer may input information about the current battlespace situation and a mission of a unit according to the battlespace situation into a model of the present disclosure trained to plan a task for a subordinate unit based on reinforcement learning in 301, and the model may perform, based on the input battlespace situation and the input mission, a battle simulation and inference through a battlespace environment simulator in 303. Through a process of the battle simulation and the inference, the model may collect a task performed by each unit and determine a task suitable to be performed by each unit present in the battlespace situation in 305 and recommend a series of determined tasks to the commander or the staff officer as task planning for each unit in 307.

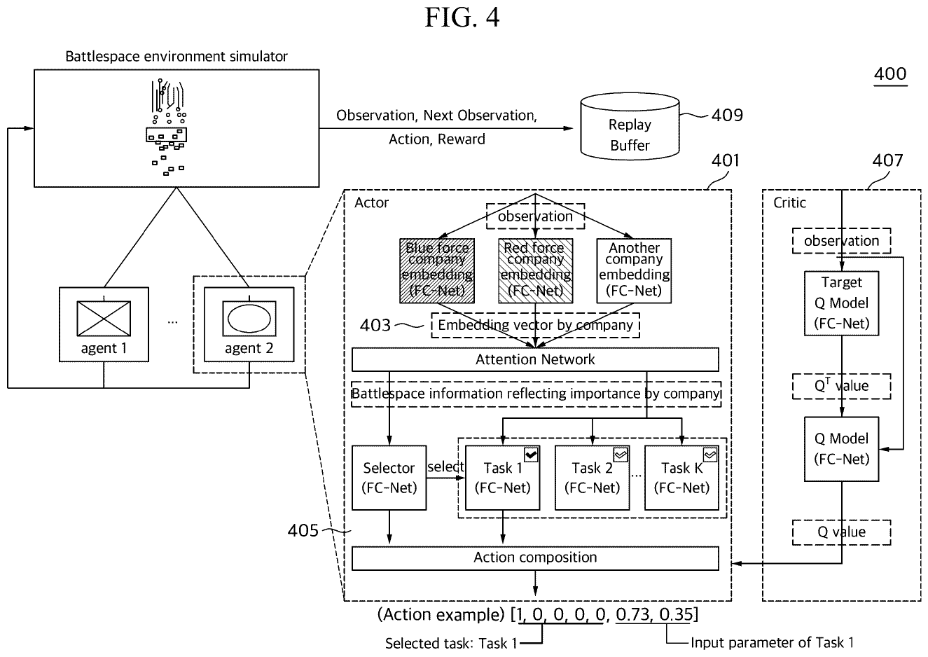

FIG. 4 is a diagram illustrating an example of a multi-agent reinforcement learning structure designed for a model.

From a perspective of a commander or a staff officer, a unit or a subordinate unit that is a target of task planning may be numerous, and when a single-agent reinforcement learning structure configuring an agent corresponding to a commander or a staff officer is applied, the number of an action space increases by the number of units, which may lead to a learning complexity increase. Accordingly, in the present disclosure, by utilizing a multi-agent reinforcement learning (MARL) structure 400 shown in FIG. 4 for a model and by configuring each unit that is a target of task planning as an agent, in other words, by configuring each agent corresponding to each unit that is a target of the task planning, an action space for each agent may be reduced and learning complexity may decrease.

The MARL structure 400 of FIG. 4 may be understood as a structure including an individual agent reinforcement learning structure 401 corresponding to an individual agent. In other words, the individual agent reinforcement learning structure 401 illustrated in FIG. 4 may be configured to correspond to each agent corresponding to a unit.

In FIG. 4, the individual agent reinforcement learning structure 401 may include an attention network structure 403 based on a concept of a graph attention network (GAT). The GAT may be understood as a technique that calculates an importance of a neighboring node around a node composing a graph, and in planning a task for a subordinate unit, when each agent corresponding to each unit performs learning, performance of multi-agent learning may increase by reflecting an importance of a different unit such as an enemy or a friendly force divided based on each agent, differently for each agent. In an example of the present disclosure including FIG. 4, with a prerequisite that all the other units are adjacent with respect to each agent on the graph of the GAT, it may be understood that the attention network structure 403 outputs battlespace information reflecting an importance of each unit with respect to a predetermined agent in the individual agent reinforcement learning structure 401 corresponding to the predetermined agent.

In addition, in FIG. 4, the individual agent reinforcement learning structure 401 may include a task selection network structure 405 determining and selecting a task suitable for each unit based on battlespace information output through the attention network structure 403. In other words, when the attention network structure 403 outputs battlespace information in the individual agent reinforcement learning structure 401 corresponding to a predetermined agent, based on the output battlespace information in the task selection network structure 405, an optimal task to be performed by a predetermined unit may be determined and selected based on the battlespace information among one or more tasks performable by the predetermined unit corresponding to the predetermined agent.

In the task selection network structure 405 of FIG. 4, a task network for each task performable by a unit corresponding to an agent may be separately provided and a parameter required for a unit to perform each task may be output, and when information on an observation related to a battlespace situation or a battlespace simulation is input into the task selection network structure 405, an optimal task determined to be most suitable to be performed by a unit corresponding to the input information on the observation may be selected and output as an action of the agent. According to FIG. 4, the task selection network structure 405 may be configured as a form including a selection network (“Selector”) and each task network (“Task K”) corresponding to each task, and in the task selection network structure 405, what is an optimal task for a unit corresponding to the input information on the observation may be selected by a task network, and as the task network corresponding to the selected task is activated, the activated task network may output input value information such as an input parameter required for performing the corresponding task.

Here, an action of an agent may be configured and output as a form of an action vector such as [a one-hot vector instructing a selected task, an input parameter of a task] to be transferred to a battlespace environment simulator. In other words, information about a task selected for a unit to perform for the action of the agent may include task instruction information for instructing the task selected for the corresponding unit to perform among one or more tasks performable by a unit and input value information for the task selected for the corresponding unit to perform. As an example, when an action vector including a parameter instructing one optimal task to be performed by a unit among five tasks and an action vector including an input parameter for the corresponding task are output, an action vector output from the task selection network structure 405 may be in a form such as [1, 0, 0, 0, 0, 0.73, 0.35], which may indicate that task 1 is selected among tasks 1 to 5, and 0.73 and 0.35 are configured for an input parameter to perform task 1.

The MARL structure 400 of FIG. 4 may be understood to correspond to a hierarchical reinforcement learning (HRL) structure. Generally in a study utilizing an existing game or wargame, one of four directions of up, down, left and right or eight directions additionally including diagonal directions is selected for an action, but in the present disclosure, unlike an environment used in a study utilizing an existing game or wargame, using an environment may be appropriate for each entity corresponding to a unit to receive a rule-based task (tactical maneuver, detour, follow-up support, occupation, seizure, and the like) that requires inputting a parameter as an instruction to perform a battlespace simulation. Considering this, through the hierarchical reinforcement learning structure shown in FIG. 4, each agent may select a task for a unit at predetermined time steps, and the selected task and an input parameter required to perform the selected task may be output. For example, in FIG. 4, it may be understood that each task network is included hierarchically in the task selection network structure 405.

In addition, in the MARL structure 400 of FIG. 4, in addition to the aforementioned structure, a Q model critic network structure 407 may be included to evaluate a task selected for a unit or an action of an agent. In the critic network structure 407, as a main network for a Q model utilized to perform reinforcement learning for an agent and a target network for a target Q model are provided, a target value required for learning corresponding to an observation is calculated in the target Q model, and whether a result value of the Q model performing reinforcement learning based on the observation corresponds to the target value calculated in the target Q model is determined to lead the Q model to conduct learning in order that the result value of the Q model corresponds to the target value of the target Q model corresponding to the identical observation. In the case of the critic network structure 407 of FIG. 4, a task selected as the most suitable for a unit corresponding to battlespace information reflecting an importance of each unit or the most suitable action of an agent may be identified as the target value through the target Q model, and the Q model may conduct reinforcement learning in order for a task or an action of an agent that corresponds to the result value output by the Q model corresponding to the aforementioned battlespace information to correspond to the target value calculated through the target Q model.

Additionally, in the MARL structure of FIG. 4, a replay buffer structure 409 that may store data about an observation identified through an interaction process between a battlespace environment simulator and a model, an action of an agent, a reward for an agent, and/or a next observation may be included.

The MARL structure 400 of FIG. 4 may structurally utilize a MARL structure, but in a process where each agent performs reinforcement learning, a single-agent reinforcement learning algorithm may be applied, and for example, a soft actor-critic (SAC) algorithm may be applied to performing reinforcement learning of each agent. In other words, each agent may be configured to learn task planning for each unit based on the single-agent reinforcement learning algorithm, and by utilizing the single-agent reinforcement learning algorithm for each agent, learning complexity may decrease. Furthermore, in the MARL structure 400 of FIG. 4, it may be assumed that each agent may obtain a global observation, and it may be understood that this is because a commander or a staff officer plans a task based on information obtained through an intelligence preparation of the battlespace (IPB) in a real battlespace situation. In the case of an existing MARL algorithm, it is assumed that each agent may only obtain a local observation and not obtain a global observation, so a separate effort may be needed to perform cooperation between agents in a state of utilizing only a local observation. However, considering a commander or a staff officer plans a task for a subordinate unit, it may be understood that a global observation about a battlespace situation may be obtained, so a single-agent algorithm, not a relatively more complex MARL algorithm, may be applied to each agent in the MARL structure 400 of FIG. 4.

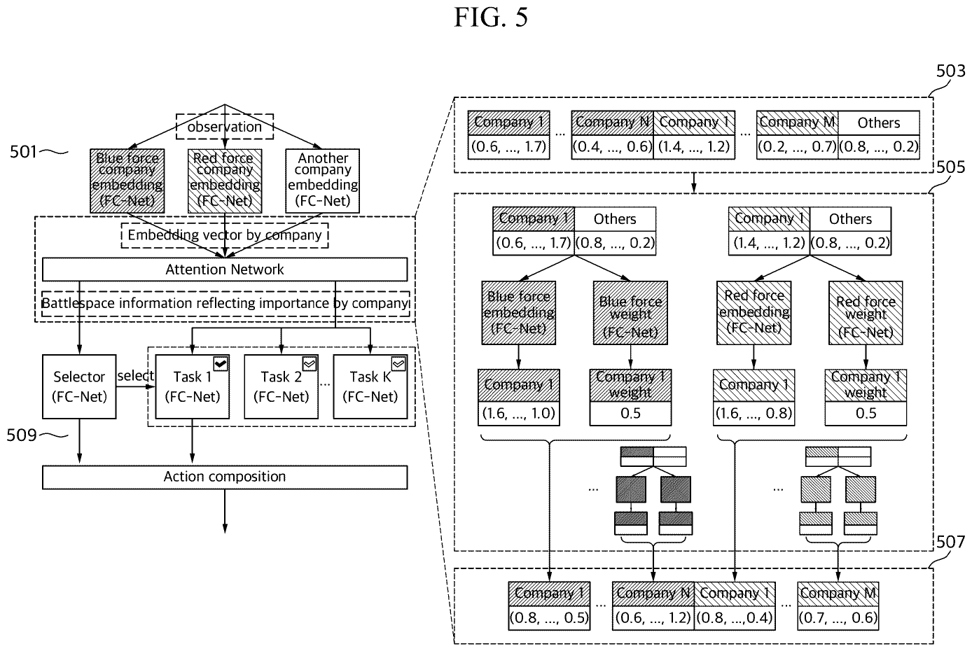

FIG. 5 is a diagram illustrating an example of an operation of an attention network structure and a task selection network structure included in a multi-agent reinforcement learning structure.

An attention network structure 501 of FIG. 5 may receive information about each unit (company) as a form of an embedding vector and may output battlespace information reflecting the importance of each company for other companies with respect to an agent. As an example of FIG. 5, the embedding vector, input to the attention network structure 501, including information about each unit corresponding to information on an observation may include embedding vectors of company 1 to company N of a blue force (a friendly force), embedding vectors of company 1 to company M of a red force (an enemy), and another embedding vector corresponding to a characteristic of an agent in 503.

In the attention network structure 501 of FIG. 5, when information on the observation is obtained, to reconfigure the information on the observation as an embedding vector by a company, an embedding network of a blue force company and an embedding network of a red force company may be provided to reorganize and calculate an embedding vector by each company based on the embedding vector by each blue force company, the embedding vector by each red force company, and the another embedding vector, and an embedding network of another information to reflect the characteristic of the agent may be additionally provided.

After the embedding vector including the information about each company corresponding to information on the observation is reorganized as the embedding vector by each company and the another embedding vector including the characteristic of the agent, the embedding vector passes through the embedding network of a blue force or a red force in 505, and through this, embedding data by each company may be made as data reflecting the characteristic of the agent, and as the embedding vector also passes through each weight network corresponding to each embedding network of the blue force or the red force, data reflecting even an importance of each unit may be made in 505 and 507. To summarize, when an embedding vector including information about each unit corresponding to information on an observation is input to the attention network structure 501 of FIG. 5, the embedding vector may be reconfigured as an embedding vector of each unit and an embedding vector corresponding to a characteristic of each agent. In addition, when a virtual battlespace simulation is conducted, based on the embedding vector of each unit and the embedding vector corresponding to the characteristic of each agent, each-unit battlespace information determined with regard to each unit and each weight determined to be assigned for each unit in the virtual battlespace simulation with respect to an agent may be identified, and it may be understood that according to an operation over each-unit battlespace information and each weight, final battlespace information reflecting an importance of each unit with respect to an agent is generated.

Through the process as described above, the embedding vector by each company may be finally obtained as an embedding vector reflecting the importance of each company with respect to an agent in 507, and battlespace information reflecting the importance by each company in the attention network structure 501 based on obtained data may be generated and output.

The battlefield information output from the attention network structure 501 may be utilized to select an optimal task for an action of an agent and a unit in the task selection network structure 509.

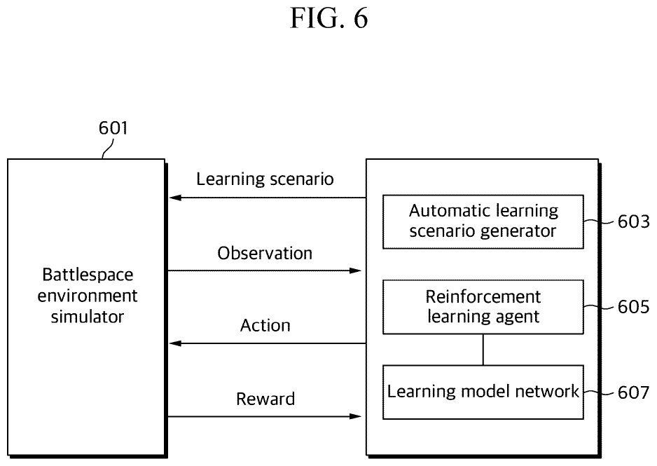

Based on the structure in FIGS. 4 and 5, when the electronic apparatus 100 configures a model learning task planning for a unit, the configured model may perform learning according to a form shown in FIG. 6 based on information transmitting and receiving with a battlespace environment simulator conducting the virtual battlespace simulation through a learning scenario.

FIG. 6 is a diagram illustrating an example of learning performed based on a model and a battlespace environment simulator.

In FIG. 6, a model configured through a reinforcement learning agent 605 and a learning model network 607 may connect to an automatic learning scenario generator 603 automatically generating a learning scenario or include the automatic learning scenario generator 603 and train the learning model network 607 while interacting with a battlespace environment simulator 601 through the electronic apparatus 100.

The battlespace environment simulator 601 may receive a learning scenario generated in the automatic learning scenario generator 603 and conduct the virtual battlespace simulation virtually simulating a battlespace situation. The automatic learning scenario generator 603 may automatically generate a random learning scenario according to an internal generation rule when one episode terminates, and an optimal action of each agent may be learned through reinforcement learning about a single scenario, but as battlespace situations (scenarios) where a military commander or a staff officer intends to plan a task are very different from each other, various learning scenarios may be configured to be arbitrarily and automatically generated for generalization of a reinforcement learning model. The learning scenario may fix or change a scenario element as shown in an example of [Table 1] to [Table 3] within a scope including an inference target scenario and may be configured to provide a new situation every learning.

TABLE 1

| Item | | Content | Note |
|---|---|---|---|
| Battlespace scope | | 20 kilometers (km) × 45 km | Fix |
| Battlespace center location | | Latitude: 38.923-38.073, | Random |
| | | Longitude: 127.203-127.353 | |
| Blue force initial location | | Predetermined range based on | Random |
| | | inference scenario | |
| Red force initial location | | Predetermined range based on | Random |
| | | inference scenario | |
| Blue force unit composition | | Reference blue force | Random |
| and combat power | | composition in Table 2 | |
| Red force unit composition | | Reference red force | Random |
| and combat power | | composition in Table 3 | |
| Red force maneuver unit task | | Departure time and access | Random |
| | | road by battalion | |
| Red force artillery unit task | | Number of artillery units | Random |
| | | allocated by target | |
| Access road | Location and | Latitude of start and end | Fix |
| information | route | | |
| | Number of | 0-2 | Random |
| | wires | | |
| | Number of | 0-2 | Random |
| | minefields | | |
| | Topographic | Topography type (flatland, | Random |
| | information | mountain land, etc.) | |
| | Vehicle | Possible/impossible | Random |
| | mobility | | |

TABLE 2

| Branch | Battalion | Company | Detailed Military strength within a company |
|---|---|---|---|
| Maneuver | Battalion 1 | 3 Companies | 3 Infantry platoons, 1 Mortar section, 0-2 |
| unit | | | Anti-tank squad, 0-1 Machine gun squad |
| | Battalion 2 | 3 Companies | 3 Infantry platoons, 1 Mortar section, 0-2 |
| | | | Anti-tank squad, 0-1 Machine gun squad |
| | Battalion 3 | 3 Companies | 3 Infantry platoons, 1 Mortar section, 0-2 |
| | | | Anti-tank squad, 0-1 Machine gun squad |
| Artillery unit | | Company 1 | 3 105M Self-propelled artillery units |
| | | Company 2 | 3 155M Artillery units |
| | | Company 3 | 1 155M Artillery unit |
| | | Company 4 | 1 155M Artillery unit |
| Tank unit | | Company 1 | 3 Tank platoons |
| Ground | | Company 1 | 1 Ground surveillance radar (GSR) section |
| surveillance | | | |
| platoon | | | |

TABLE 3

| Branch | Battalion | Company | Detailed Military strength within a company |
|---|---|---|---|
| Maneuver | Battalion 1 | 3 Companies | 3 Infantry platoons, 1 Mortar section, 0-2 |
| unit | | | Anti-tank squad, 0-1 Machine gun squad |
| | Battalion 2 | 3 Companies | 3 Infantry platoons, 1 Mortar section, 0-2 |
| | | | Anti-tank squad, 0-1 Machine gun squad |
| | Battalion 3 | 3 Companies | 3 Infantry platoons, 1 Mortar section, 0-2 |
| | | | Anti-tank squad, 0-1 Machine gun squad |
| Artillery unit | | Company 1 | 3 105M Self-propelled artillery units |
| | | Company 2 | 3 155M Artillery units |
| | | Company 3 | 1 155M Artillery unit |
| | | Company 4 | 1 155M Artillery unit |
| Tank unit | | Company 1 | 3 Tank platoons |
| Ground | | Company 1 | 1 Ground surveillance radar (GSR) section |
| surveillance | | | |
| platoon | | | |

To configure the learning scenario, various scenario content may be configured for various scenario items as described in [Table 1], and whether each scenario content is randomly embodied or embodied with fixed content according to a progress of the virtual battlespace simulation may be configured for each scenario item.

If, among scenario items of [Table 1], a detailed scenario content about “Blue force unit composition and combat power” is to be configured, the learning scenario may be generated by configuring a specific detailed item and detailed scenario content corresponding to each detailed item as shown in [Table 2], and likewise, and if a detailed scenario content about “Red force unit composition and combat power” is to be configured, the learning scenario may be generated by configuring a specific detailed item and detailed scenario content corresponding to each detailed item as shown in [Table 3]. Configuring an item and content of the learning scenario as shown in [Table 1] to [Table 3] may be managed to be automatically generated as described above.

Information or data that the model and the battlespace environment simulator 601 transmit and receive based on the electronic apparatus 100 in FIG. 6 may include, in addition to the aforementioned learning scenario, an observation received from the battlespace environment simulator 601 according to a progress of the virtual battlespace simulation, an action of a reinforcement learning agent corresponding to the observation, a reward assigned to the reinforcement learning agent according to the action, and a new observation received from the battlespace environment simulator 601 when the action of the reinforcement learning agent is reflected in the virtual battlespace simulation, and the transmitting and receiving of information or data described above may be repeated in the progress of the virtual battlespace simulation.

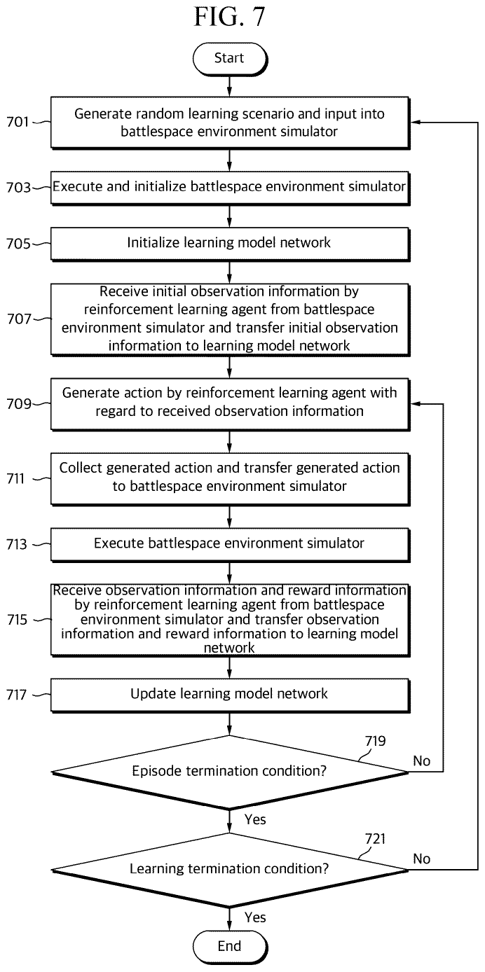

FIG. 7 is a diagram illustrating an entire flowchart in which learning for task planning for a unit is performed according to an example embodiment of the present disclosure.

In FIG. 7, when learning is begun, the electronic apparatus 100 may generate a random learning scenario through an automatic learning scenario generator and input the generated learning scenario into a battlespace environment simulator in operation 701. When it is identified that the learning scenario is input, the electronic apparatus 100 may initialize the battlespace environment simulator to conduct a virtual battlespace simulation and a learning model network to perform learning in operation 703 and operation 705.

When the virtual battlespace simulation is begun according to the input learning scenario, the electronic apparatus 100 may receive each initial observation information identified from each unit or each agent from the battlespace environment simulator to transfer each initial observation information to the learning model network in operation 707 and may collect, from a model, a task to be performed by each unit in the virtual battlespace simulation corresponding to each initial observation information, in other words, an action of each agent corresponding to each initial observation information, to transfer the task or the action to the battlespace environment simulator in operation 709 and operation 711.

The electronic apparatus 100 may allow the battlespace environment simulator to conduct the virtual battlespace simulation based on a time step configured in advance inside the battlespace environment simulator to reflect the action of each agent corresponding to each initial observation information in operation 713, and since a result of conducting the virtual battlespace simulation is keep changing with reflection of the action of each agent corresponding to each initial observation information, according to the result, the electronic apparatus 100 may receive and identify each observation information identified from each unit or each agent and each reward information about each agent according to each observation information and transfer each observation information and each reward information again to the learning model network in operation 715.

The electronic apparatus 100 may update the learning model network based on each observation information identified from each agent and each reward information about each agent according to each observation information in operation 717, and may repeat the process of operation 709 to operation 717 that updates a model by inputting an action of an agent into the battlespace environment simulator and in response thereto, obtaining observation information and reward information about the agent until an episode termination condition of the virtual battlespace simulation is satisfied in operation 719, or repeat the process of FIG. 7 until a learning termination condition of reinforcement learning for task planning for a unit is satisfied in operation 721. The episode termination condition may include a condition of maximum simulation time elapsing, a condition of a friendly force winning, and/or a condition of an enemy winning, and the learning termination condition may include a condition of maximum learning time elapsing, and/or a condition of determining a reward curve converges.

The present disclosure above, as a method of planning a task for a subordinate unit by utilizing reinforcement learning and an apparatus supporting thereof, suggests a structure to use various military tasks that an existing technology fails to handle as an action of an agent and to plan a task for a subordinate unit through reinforcement learning. Based on the present disclosure, task planning for a subordinate unit for a military commander or a staff officer to establish in a battlespace situation may be rapidly established through a scientific approach, and a limitation may be resolved, caused by the experience-dependent manner of a decision maker in an existing technology, such as a change in the quality of decision-making results depending on an individual capability, and difficulty in a thorough review of a variety of information and situations even though rapid decision-making is required in a real battlespace situation.

In the aforementioned description, even though all elements composing example embodiments disclosed in the present disclosure are explained to be combined as one or operate by being combined, example embodiments disclosed in the present disclosure are not limited thereto. In other words, within a range of a goal of example embodiments disclosed in the present disclosure, all elements may operate by being selectively combined as more than one.

In addition, as terms such as “comprise or include,” “configure,” or “have,” unless particularly otherwise indicated, may refer to including a corresponding element, it should be construed to further include other elements, not exclude other elements. All terms including a technical or scientific term, unless otherwise defined, have a meaning that those skilled in the art generally understand. Terms generally used as those defined in a dictionary should be construed as matching with a contextual meaning of related art, and unless otherwise clearly indicated in the present disclosure, should not be construed as having an ideally or excessively perfunctory meaning.

The aforementioned description is merely an exemplary description of the technical idea disclosed in the present disclosure, and it is understood by those skilled in the art that various modifications and equivalent arrangements included within the original characteristic of example embodiments disclosed in the present disclosure. Accordingly, example embodiments disclosed in the present disclosure are not to limit but to explain a technical idea of the example embodiments disclosed in the present disclosure, and the scope of a technical idea disclosed in the present disclosure is not limited according to these example embodiments. The scope of protecting the technical ideas disclosed in the present disclosure should be construed by the appended claims, and all technical ideas within the equivalent scope thereof should be construed to be included in the scope of the present disclosure.

1. A method of configuring a model by an electronic apparatus, the method comprising:
designing a multi-agent reinforcement learning structure to perform reinforcement learning based on each agent configured to correspond to each military unit identified as a target of task planning in a virtual battlespace simulation; and
configuring a model performing reinforcement learning related to task planning for each military unit based on the multi-agent reinforcement learning structure,
wherein the multi-agent reinforcement learning structure is designed to include each agent reinforcement learning structure configured to correspond to each agent in order that each agent learns the task planning for each military unit,
wherein each agent reinforcement learning structure comprises:
an attention network structure generating battlespace information reflecting an importance of each military unit based on information about each military unit identified through the virtual battlespace simulation; and
a task selection network structure determining and selecting a task to be performed by each military unit based on the battlespace information among one or more tasks performable by each military unit in the virtual battlespace simulation,
wherein the task selection network structure includes a selection network selecting the task to be performed by each military unit among the one or more tasks and one or more task networks respectively corresponding to the one or more tasks, and
wherein when a specific task is selected among the one or more tasks by the selection network, a specific task network corresponding to the specific task among one or more task networks is activated and the activated specific task network is set to output input value information for performing the specific task.

2. The method of claim 1, wherein an embedding vector including the information about each military unit is input into the attention network structure,
wherein the embedding vector including the information about each military unit is reconfigured to an embedding vector of each military unit and an embedding vector corresponding to a characteristic of each agent,
wherein, based on the embedding vector of each military unit and the embedding vector corresponding to the characteristic of each agent, each unit battlespace information determined with regard to each military unit and each weight assigned to each military unit with respect to each agent in the virtual battlespace simulation are calculated, and
wherein the battlespace information reflecting the information about each military unit is generated based on an operation over each unit battlespace information and each weight.

3. (canceled)

4. The method of claim 1, wherein each agent is configured to learn the task planning for each military unit based on a single-agent reinforcement learning algorithm.

5. The method of claim 1, wherein a learning scenario for the virtual battlespace simulation is configured to be automatically generated.

6. The method of claim 1, further comprising:
beginning the virtual battlespace simulation according to a learning scenario based on a battlespace environment simulator;
in response to the beginning of the virtual battlespace simulation, obtaining each initial observation information identified with regard to each military unit from the battlespace environment simulator; and
obtaining information, which is output by the model corresponding to each initial observation information, about the task to be performed by each military unit.

7. The method of claim 6, further comprising:
inputting the information about the task to be performed by each military unit into the battlespace environment simulator;
in response to a result of conducting the virtual battlespace simulation on the battlespace environment simulator based on inputting the information about the task to be performed by each military unit, identifying each observation information identified with regard to each military unit and each reward information about each agent according to each observation information; and
updating the model based on each observation information and each reward information.

8. The method of claim 7, wherein updating the model is performed until an episode termination condition of the virtual battlespace simulation and a learning termination condition of the reinforcement learning for the task planning of each military unit are satisfied.

9. A non-transitory computer-readable storage medium having a program for executing a method of configuring a model on a computer, the method comprising:
designing a multi-agent reinforcement learning structure to perform reinforcement learning based on each agent configured to correspond to each military unit identified as a target of task planning in a virtual battlespace simulation; and
configuring a model performing reinforcement learning related to task planning for each military unit based on the multi-agent reinforcement learning structure,
wherein the multi-agent reinforcement learning structure is designed to include each agent reinforcement learning structure configured to correspond to each agent in order that each agent learns the task planning for each military unit, and
wherein each agent reinforcement learning structure comprises:
importance of each military unit based on information about each military unit identified through the virtual battlespace simulation; and
a task selection network structure determining and selecting a task to be performed by each military unit based on the battlespace information among one or more tasks performable by each military unit in the virtual battlespace simulation,
wherein the task selection network structure includes a selection network selecting the task to be performed by each military unit among the one or more tasks and one or more task networks respectively corresponding to the one or more tasks, and
wherein when a specific task is selected among the one or more tasks by the selection network, a specific task network corresponding to the specific task among one or more task networks is activated and the activated specific task network is set to output input value information for performing the specific task.

10. An electronic apparatus configuring a model, the electronic apparatus comprising:
a processor; and
one or more memories configured to store one or more instructions,
wherein the one or more instructions, when executed, control the processor to perform:
designing a multi-agent reinforcement learning structure to perform reinforcement learning based on each agent configured to correspond to each military unit identified as a target of task planning in a virtual battlespace simulation; and
configuring a model performing reinforcement learning related to task planning for each military unit based on the multi-agent reinforcement learning structure,
wherein the multi-agent reinforcement learning structure is designed to include each agent reinforcement learning structure configured to correspond to each agent in order that each agent learns the task planning for each military unit, and
wherein each agent reinforcement learning structure comprises:
importance of each military unit based on information about each military unit identified through the virtual battlespace simulation; and
a task selection network structure determining and selecting a task to be performed by each military unit based on the battlespace information among one or more tasks performable by each military unit in the virtual battlespace simulation,
wherein the task selection network structure includes a selection network selecting the task to be performed by each military unit among the one or more tasks and one or more task networks respectively corresponding to the one or more tasks, and
wherein when a specific task is selected among the one or more tasks by the selection network, a specific task network corresponding to the specific task among one or more task networks is activated and the activated specific task network is set to output input value information for performing the specific task.
